(19) United States
(12) Patent Application Publication
(10) Pub. No.: US 2021/0237084 A1
(43) Pub. Date: Aug. 5, 2021

(54) SAMPLE RACK AND SAMPLE CARRIER SYSTEM

(71) Applicant: TECAN TRADING AG, Mannedorf (CH)

(72) Inventors: Markus WOLF, Mannedorf (CH); Fred SCHINZEL, Mannedorf (CH)

(73) Assignee: TECAN TRADING AG, Mannedorf (CH)

(21) Appl. No.: 16/967,648

(22) PCT Filed: Feb. 19, 2018
(86) PCT No.: PCT/EP2018/054045

§ 371 Date: Aug. 5, 2020

(51) Int. Cl. B01L 3/00; G01N 35/00

(52) U.S. Cl. CPC B01L 3/5453; G01N 35/00732; G01N 2035/00396; B01L 2300/021; G01N 2035/00752; G01N 2035/00762; G01N 2035/00801

(57) ABSTRACT

A sample rack that has at least one axially extended receptacle for a sample tube (30). The sample rack has a code arrangement on its outside. This code arrangement contains information regarding the position of the at least one receptacle as well as information regarding the total number of receptacles and/or the dimension of the sample rack. A sample carrier system (1) is further provided that has a sample carrier with at least one sample rack receptacle and a set of sample racks. The sample rack receptacle and the sample racks have interacting mechanisms which characterize their affiliation.

### FIELD AND BACKGROUND OF THE INVENTION

### Field of the Invention

The present invention relates to a sample rack for positioning samples and reagents and a sample carrier system for introducing the samples and reagents contained in the sample rack into an automatic analysis device.

### Background of the Invention

If a large number of samples have to be measured in the shortest possible time, the use of automatic analysis devices is the best option. These are designed for the determination of one or more analytes in a large number of provided samples and are often used for routine analyses in the health sector. However, it is particularly important here that the analytical results are as reliable as possible and can be clearly assigned to the sample or its origin. However, the risk of sample mix-up increases with the number of samples to be analyzed and the professional handling of the reagents to be used becomes even more complicated, especially if different reagents are to be used and the same analysis program is not run for all samples in the automatic analysis device. In addition to the danger of confusion regarding the sample or the sample origin, it is also possible that the reagents are mixed up, so that an incorrect analysis result can also be obtained in this way.

Although there are already various ways of supplying the automatic analysis device with information about the samples to be analyzed or about the reagents required for the analysis and their position, these are usually complex and limited in their performance. A standard procedure, for example, is to provide the sample tubes containing the samples or reagents with a barcode and to scan each individual tube by hand. After scanning a tube, the software tells the user where to position the tube in the automatic analysis device. There is no control mechanism to check whether the tube has actually been positioned at the intended location. Accordingly, such a system is susceptible to errors caused by incorrect assignment of an analysis result to a sample. Furthermore, this procedure is particularly difficult for sensitive samples or reagents that have to be cooled, for example, because no controlled environment can be created by individual insertion. One consequence can be a falsified analysis result due to a degenerated sample or reagent.

To create a controlled environment, but also to improve handling, sample racks equipped with position barcodes can be used. For example, the sample rack can be a block cooled with water snakes or Peltier elements, which keeps the samples or reagents stable until the actual analysis. In this case, the sample tubes do not have to be inserted individually into the automatic analysis device, but are first placed in the sample rack, also called sample stand, at the exact position in the sample rack that was assigned to this sample tube by the software after scanning with the hand scanner. Once the sample rack is filled, it can be inserted into the automatic analysis device. The automatic analysis device, in turn, contains its own scanner, which then reads the position barcode on the sample rack and thus knows which sample is being analyzed by means of the previous assignment “sample/reagent to position in sample rack” specified by the software and carried out by the user. However, errors can also occur here in the assignment of analysis results to the samples, as it cannot be ensured that a sample or reagent has actually been placed by the user at the position in the sample rack intended for this sample or reagent. From patent application WO2018015483 (A1), for example, a carrier unit (often referred to as a “strip rack”) is known, into which sample tubes, each provided with a barcode, are inserted. The carrier unit itself can be identified by means of a barcode applied to it. Such a carrier unit is then usually inserted manually along an insertion path on a work area. The barcode reader unit arranged on the work area must be designed and arranged relative to the insertion path in such a way that the barcode of each individual sample tube can be read or recognized unhindered and reliably when the carrier unit is introduced or inserted.

### SUMMARY OF THE INVENTION

It is the object of the present invention to provide a sample rack that minimizes errors in the analysis of samples or even eliminates sources of error. A further aspect of the present invention is to provide a sample carrier system which minimizes errors in the analysis of samples or even excludes sources of error.

The object is solved by a sample rack, which comprises at least one axially extended receptacle for a sample tube and a code arrangement arranged on the outside of the sample rack. The code arrangement contains information regarding the position of the at least one receptacle as well as information regarding the total number of receptacles and/or the dimension of the sample rack.

From such a code arrangement it can be read off on the one hand which position is assigned to a receptacle. For example, if there are five receptacles in total, the positions 1, 2, 3, 4 and 5 can be assigned. As an alternative to such position numbers or position symbols (instead of 1, 2, 3 . . . the positions can also be called A, B, C . . . or similar), the position of a receptacle can also mean its location coordinates, i.e. its absolute or relative position (position in the sense of location indication) in the sample rack. For example, in a sample rack which is 18 cm long and 6 cm wide and has five receptacles for sample tubes arranged in a row, the five positions “3/3”, “6/3”, “9/3”, “12/3” and “15/3” can be assigned to the receptacles. The positions defined in this way (specified in “Length [cm]/Width [cm]”) are due to the position of the individual receptacles in relation to the length and width of the sample rack. On the other hand, it can also be read from such a code arrangement how many receptacles, and thus positions, the sample rack comprises in total and/or which dimension (e.g. length, width and/or height), in particular size (e.g. relative length, width and/or height alias small, medium, large), the sample rack has. For example, there can be three different sizes of sample racks and the code arrangement can be used to read out whether the sample rack is small, medium or large. Alternatively, the code arrangement can also indicate whether it is a sample rack with, for example, a total of seven, ten or twelve receptacles. The actual dimension of two sample racks can also be identical (e.g. medium size), but one holds seven large sample tubes, the other holds ten small sample tubes. In this case it is useful if the code arrangement informs on the one hand how many receptacles are available and on the other hand for which type of sample tubes these receptacles are suitable. In addition to or instead of the number of receptacles, the dimension can also be indicated (e.g. medium size) in combination with an indication of the type of sample tube for which the sample rack is suitable. Furthermore, the code arrangement can contain information, for example, whether the sample rack is a sample rack whose receptacles for sample tubes are arranged in one row or in two or more rows. In addition, in the case of a multi-row arrangement, the code arrangement can contain information on whether the tube receptacles in one row (e.g. first row) are offset from or at the same height as the tube receptacles in another row (e.g. second row).

It should be noted that, although there is literal reference to a receptacle for a sample tube and therefore a sample tube, such a sample tube does not necessarily have to contain a sample to be analyzed, but such a sample tube may also contain a reagent used for analysis and the tube may also be designed as a vial. Accordingly, the invention, its further aspects and all its embodiments are applicable to samples to be analyzed, but also to reagents used for the analysis, including washing liquids, buffer solutions or other dilution solutions. Accordingly, the sample rack can also be a reagent rack, the sample carrier can also be a reagent carrier, and the sample carrier system can also be a reagent carrier system.

In an embodiment of the sample rack according to the invention, which may be combined with any of the embodiments yet to be named, unless contradictory thereto, the code arrangement includes a code associated with one receptacle and contains information regarding the position of that one receptacle.

In such an embodiment, for example, the number of codes in the code arrangement is identical to the number of receptacles, i.e. each receptacle has its own code, which contains information about its position, for example. Furthermore, such a code can contain information regarding the total number of receptacles and/or the dimension of the sample rack. However, this type of information can also be stored on one or more additional codes of the code arrangement, so that such a code arrangement comprises in total at least one code more than the sample rack has receptacles.

In an embodiment of the sample rack according to the invention, which can be combined with any of the aforementioned embodiments and with any of the embodiments yet to be named, unless contradictory thereto, the code arrangement comprises a code containing information relating to the position of a plurality of receptacles, in particular information relating to the position of the plurality of receptacles relative to the position of this code.

With such an embodiment, it is possible, for example, that the code arrangement as a whole comprises only one code, which, in addition to information regarding the total number of receptacles and/or the dimension of the sample rack, also comprises information regarding the position of the several receptacles, for example their position relative to the position of the code. For example, the following information can be read from the one code of the code arrangement with the coordinates (x=0; y=0; z=0) (Note: The position of the coordinate axis can be taken from FIG. 1; the specification of the coordinates can have the unit cm, for example)
Sample carrier with 7 receptacles;
relative position of receptacle 1 to code (−9; 0; +1);
relative position of receptacle 2 to code (−6; 0; +1);
relative position of receptacle 3 to code (−3; 0; +1);
relative position of receptacle 4 to code (0; 0; +1);
relative position of receptacle 5 to code (+3; 0; +1);
relative position of receptacle 6 to code (+6; 0; +1);
relative position of receptacle 7 to code (+9; 0; +1).

In addition, the code arrangement can contain at least one of the following information, for example:
the receptacles are suitable for small or large sample tubes;
it is a sample rack of small, medium or large size.

In an embodiment of the sample rack according to the invention, which can be combined with any of the embodiments already mentioned and with any of the embodiments yet to be named, unless contradictory thereto, the sample rack comprises at least one inspection window which allows the view into at least one receptacle.

Such an inspection window may be formed, for example, by an insert of transparent material (e.g. glass or plastic), by a material recess or a combination thereof. The inspection window allows, for example, the scanning of a barcode on the sample tube or the reading of other labels or imprints. The inspection window can also be used to determine the volume in the sample tube or a color change.

In an embodiment of the sample rack in accordance with the invention, which can be combined with any of the embodiments already mentioned and with any of the embodiments yet to be named, unless contradictory thereto, the sample rack comprises retaining elements for lids of the sample tubes, in particular projections.

Often the lids of the sample tubes are wetted with sample after transport or by shaking, so that, for example, after opening the lids, contamination by dripping sample and/or cross-contamination by swapping lids can occur. To eliminate such sources of contamination, it is advisable to provide a safe storage place for the lids of the opened sample tubes. For example, a safe place for the lids of the opened sample tubes is located directly adjacent to the respective sample tube so that the removed lid does not have to be transported over another sample tube. If sample tubes are used whose lids are connected to the sample tube via a plastic ring, contamination can be prevented by swapping the lids, but contamination by dripping or splashing sample can still occur. However, if the lid is held by retaining elements after controlled opening, this type of contamination can also be avoided.

In an embodiment of the sample rack in accordance with the invention, which can be combined with any of the embodiments already mentioned and with any of the embodiments yet to be named, unless contradictory thereto, the sample rack comprises a gripping device, in particular at least one holding bracket and/or at least one holding tab.

With the help of the gripping device, which is located, for example, on the top or the left and/or right side of the sample rack, the user or, in the case of more advanced automation, the robot arm can position and remove the sample rack in the automatic analysis device in a simplified manner.

In an embodiment of the sample rack in accordance with the invention, which can be combined with any of the embodiments already mentioned and with any of the embodiments yet to be named, unless contradictory thereto, a part of the gripping device forms a support surface for lids of the sample tubes.

If the lids are not only held back, but rest on a support surface, they can be fixed even more reliably. It also prevents sample from dripping from the lid into the automatic analysis device.

In an embodiment of the sample rack in accordance with the invention, which can be combined with any of the embodiments already mentioned and with any of the embodiments yet to be named, unless contradictory thereto, at least one receptacle comprises an empty code which contains information regarding the absence of a sample tube in the receptacle.

If an incompletely loaded sample rack is used, the scanner simply detects at which position a sample tube is located and at which it is not, so that samples are taken only at those positions and reagents are dispensed only at those positions where a sample tube filled with a sample is actually located. Without the empty code, the system might not know what to do at the empty position, since the information of the barcode on the sample tube is missing. For example, an empty code can be placed inside each receptacle so that the empty code can be read through the inspection window of the respective receptacle and would be covered by the receptacle if a sample tube was present in the receptacle.

One aspect of the invention relates to the provision of a sample carrier system according to claim 9. The sample carrier system which may be combined with any of the aforesaid embodiments of the sample rack and with any of the embodiments of the sample carrier system yet to be named, unless contradictory thereto, comprises a sample carrier having at least one sample rack receptacle and a set of sample racks. The sample rack receptacle and the sample racks have interacting means to indicate their affiliation.

By marking the affiliation of the individual sample racks of the set to the sample rack receptacle, a mix-up or an incorrect insertion of a sample rack into a sample rack receptacle not intended for it can be made more difficult or even prevented. The identification can include, for example, a color coding, but mechanical markings or sensory markings can also be used additionally or alternatively. Further details are explained in the following embodiments.

In an embodiment of the sample carrier system in accordance with the invention, which can be combined with any of the embodiments already mentioned and with any of the embodiments yet to be named, unless contradictory thereto, the interacting means are interacting mechanical means designed in such a way that only certain sample racks of the set can be placed in the sample carrier in the desired position.

These can be, for example, complementary projections and recesses on the sample rack and sample rack receptacle. If, for example, the sample rack receptacle has a wedge-shaped guide groove and the sample rack has a complementary wedge-shaped projection, this projection can be splinted into the guide groove and the sample rack can be inserted into the sample rack receptacle along the guide groove. If, however, an attempt is made to insert a sample rack with a projection of semicircular cross-section into the sample rack receptacle, the attempt fails because the projection cannot be inserted into the guide groove. If, for example, a colored marking or a marking with symbols, numbers or the like is additionally attached to the sample rack receptacles and the sample racks, a wrong assignment is only prevented by mechanical means in exceptional cases as the last safety instance, since the user is already instructed by the colored marking or the like to insert only corresponding sample racks into the corresponding sample rack receptacle.

In an embodiment of the sample carrier system in accordance with the invention, which can be combined with any of the embodiments already mentioned and with any of the embodiments yet to be named, unless contradictory thereto, the interacting means comprise at least one identifier and at least one identifier reader. The identifier reader is in particular a Hall sensor and the identifier in particular a magnet.

As an alternative to or in combination with the mechanical means, the interacting means can also be an identifier and an identifier reader. Such an identifier could be, for example, a magnet, which is located on the back of the sample rack, for example. The sample rack receptacle, on the other hand, has a Hall sensor that detects whether the sample rack that has just been inserted into the sample rack receptacle has a magnet or not. If the sample rack receptacle only has sample racks that have a magnet, an alarm or an error message is triggered, indicating that an unrelated sample rack without magnet has been inserted. The larger the number of Hall sensors and magnets, the more associated sample racks can be marked. On the one hand, a Hall sensor can indicate the presence or absence of a magnet (ratio of sensors to magnets 1:1; whole positions are determined). But there can also be e.g. only two Hall sensors on three magnets, so that not only the presence and absence can be distinguished, but also a half position (located between two sensors) can be determined. The combinatorial possibilities from three magnet positions can thus be used with only two sensors.

The identifier can also be an RFID tag (RFID stands for radio-frequency identification) and the identifier reader can be an RFID reader. However, care should be taken to ensure that the reader and the tag can be brought sufficiently close together to prevent an RFID tag from being read that is not part of the interacting means. Furthermore, the antenna size of the RFID reader can be designed so that only RFID tags located within a predefined radius can be read. In order to ensure sufficient proximity, the RFID reader can, for example, be located on an inner wall of a sample rack of a sample carrier, especially in a recess, such as a milled or lowered part of the inner wall, which recess can also be sealed to protect the RFID reader. The RFID tag, in turn, can be attached to an outer wall of a sample rack. The RFID tag can in particular also be placed in a recess, such as a cut-out or recess in the outer wall, which can also be sealed to protect the RFID tag. The position of the RFID tag in/on the outer wall of the sample rack and the position of the RFID reader in/on the inner wall of the sample carrier is chosen so that the tag and reader are close to each other while the sample rack is inserted into the sample rack receptacle or when it is inserted. In one variant, the RFID tags of the sample racks and the RFID readers of the sample rack receptacles can be arranged in such a way that only the RFID tag and the RFID reader of an associated sample rack/sample rack receptacle pair can be brought sufficiently close together for the reader to read/detect the tag at all. It is also conceivable to arrange several RFID readers on the inside of the sample rack receptacles and one or more RFID tags on the outside of a sample rack. Each of the readers detects whether an RFID tag is present in its vicinity or not. For example, there are a total of 5 readers, wherein a sample rack with the tag arrangement 0-1-0-1-1 is associated with a sample rack receptacle. An affiliation is only provided if the sample rack inserted into this sample rack receptacle does not have an RFID tag near the first and the third reader, but does have a tag near the second, fourth and fifth reader. The underlying functionality of this type of affiliation is described in more detail in FIG. 10, for example.

A two-stage system is also conceivable in which, on the one hand, the affiliation is made via an arrangement of tags corresponding to an arrangement of readers and, on the other hand, via the information that the readers can actually extract from the tags.

In an embodiment of the sample carrier system in accordance with the invention, which can be combined with any of the embodiments already mentioned and with any of the embodiments yet to be named, unless contradictory thereto, a certain sample rack from the set is only associated with a certain sample rack receptacle.

Accordingly, the sample carrier system of such an embodiment includes the same number of sample rack receptacles as sample racks.

In an embodiment of the sample carrier system in accordance with the invention, which can be combined with any of the embodiments already mentioned and with any of the embodiments yet to be named, unless contradictory thereto, at least two sample racks from the set are associated with a specific sample rack receptacle.

A sample carrier system of such an embodiment accordingly comprises a larger number of sample racks than sample rack receptacles. This type of embodiment is advantageous, for example, if the sample racks contain vials with sensitive reagents that are consumed during the analysis procedure, but it is not possible to introduce a large supply of these reagents into the automatic analysis device due to their sensitivity. If the reagents in a sample rack are used up, this sample rack can be removed from the sample carrier and replaced by a second sample rack which has been stored in a controlled environment (e.g. cooled and/or darkened) until now. This second sample rack contains vials already filled with the required reagents and is part of the same sample rack receptacle as the previously removed sample rack. The at least two sample racks from the set, which belong to one and the same specific sample rack receptacle, can be of identical construction. This means that they have the same dimensions and/or the same number of positions. Alternatively, two or more sample racks with different dimensions and/or number of positions can be used. In this way, the sample rack receptacle of the sample carrier can be equipped with samples and/or reagents individually and depending on the analysis process.

If at least two sample racks from the set are associated with a particular sample rack receptacle, the code arrangement may, for example, contain information about which sample rack from the set it is. For example, if there are three sample racks (A, B and C) that belong to a certain sample rack receptacle, the code arrangement can be used to determine whether the sample rack in question is sample rack A, B or C.

In an embodiment of the sample carrier system in accordance with the invention, which can be combined with any of the embodiments already mentioned and with any of the embodiments yet to be named, unless contradictory thereto, the sample carrier comprises at least two sample rack receptacles of different dimensions, to which a specific sample rack from the set belongs.

This embodiment allows the flexible use of a sample rack in the sample carrier itself. A small sample rack (e.g. for holding seven sample tubes) does not necessarily have to be placed in the correspondingly dimensioned sample rack receptacle, but can also be placed in a larger sample receptacle (e.g. for sample racks with ten sample tubes).

In an embodiment of the sample carrier system in accordance with the invention, which can be combined with any of the embodiments already mentioned and with any of the embodiments yet to be named, unless contradictory thereto, the set comprises at least one further sample rack, which is associated with at least one of the two sample rack receptacles of different dimensions. The at least one further sample rack has in particular a different dimension and/or different total number of receptacles. The position of the receptacles of the different sample racks is preferably different in the same sample rack receptacle.

Such an embodiment increases the flexibility of use of the sample carrier system. For example, the sample carrier can have five sample rack receptacles, two of which are large sample rack receptacles (e.g. for holding sample racks with ten sample tubes each) and three are small sample rack receptacles (e.g. for holding sample racks with seven sample tubes each). If the set of sample racks contains two large sample racks as well as four small sample racks (and not only three small sample racks, as is the case with a ratio of 1:1 (sample rack:sample rack receptacle), one of which not only belongs to one of the small sample rack receptacles but also to one of the large sample rack receptacles, the sample tubes inserted into this sample rack can be analyzed either in the large sample rack receptacle or in the small sample rack receptacle. By selecting the sample rack, the number of samples to be analyzed can be adjusted without having to exchange the sample carrier itself.

If the position of the receptacles for the sample tubes in the small sample rack and in the large sample rack is now selected in such a way that the position of the receptacles of one (e.g. large) sample rack differs from the position of the receptacles of the other (e.g. small) sample rack when inserted into the sample rack, a pipetting robot, for example, can recognize from the different position of the receptacles that the wrong sample rack has been inserted into the sample rack receptacle. An error message or an interruption of the automated analysis then makes it possible to correct the error.

In an embodiment of the sample carrier system in accordance with the invention, which can be combined with any of the embodiments already mentioned and with any of the embodiments yet to be named, unless contradictory thereto, the interaction of the mechanical means is based on the key-lock principle.

The key-lock principle describes two or more complementary structures that must fit together spatially to fulfil their function. For example, the mechanical means can be designed in such a way that they mark the affiliation of the sample rack and sample rack receptacle according to this principle. For example, the sample rack may have a pattern of projections on its underside (“key”), whereas the sample rack receptacle has depressions (“lock”) complementary to the projections, so that the sample rack can be inserted into the sample rack receptacle. The sample carrier is then ready for use, i.e. ready to fulfil its function.

In an embodiment of the sample carrier system in accordance with the invention, which can be combined with any of the embodiments already mentioned and with any of the embodiments yet to be named, unless contradictory thereto, the interacting mechanical means are formed by at least one of the following or a combination thereof
at least one guide groove on a sample rack, in particular on its outside, and at least one guide projection on a sample rack receptacle, in particular on at least one side delimiting the sample rack receptacle;
at least one guide projection on a sample rack, in particular on its outside, and at least one guide groove on a sample rack receptacle, in particular on at least one side delimiting the sample rack receptacle;
at least one recess on a sample rack, in particular at the bottom thereof, and at least one pin on a sample rack receptacle, in particular at the bottom thereof;
at least one pin on a sample rack, in particular on its bottom, and at least one recess on a sample rack receptacle, in particular on the bottom thereof.

The mechanical means, as described above, can be designed in various ways, and it is also possible to combine these types with each other. For example, a sample rack can have a pattern of pins and recesses on the floor and the sample rack receptacle belonging to this sample rack can have a correspondingly complementary pattern of pins and recesses. In addition, a corresponding pair of sample racks/sample rack receptacle can have pins and grooves as well as guide projections and guide grooves. Alternatively, the sample rack may have more than one guide groove and/or more than one guide projection. These multiple guide grooves and/or guide projections can be adjacent to each other or spaced apart. For example, one guide groove may be located on the left side and another guide groove on the right side. Also, several guide grooves can be arranged on the back of the sample rack, even though next to each other. The above described embodiments can of course be transferred to the correspondingly designed sample rack receptacles.

In an embodiment of the sample carrier system in accordance with the invention, which can be combined with any of the embodiments already mentioned and with any of the embodiments yet to be named, unless contradictory thereto, the sample carrier comprises at least one temperature control unit which enables heating, cooling and/or maintaining a temperature or a temperature range, in particular at least one line for a cooling fluid and/or at least one Peltier element.

If the sample carrier system is equipped with a temperature control unit, sensitive samples can be stabilized and preserved longer by cooling, and reactions taking place in the sample tubes can be controlled by increasing and/or decreasing the temperature. For example, the total analysis time can be shortened by adding heat to the samples when an endothermic reaction takes place. Possible cooling fluids are e.g. water, but also other coolants or coolant mixtures, such as liquids otherwise known as solvents, such as alcohols (ethanol, isopropanol, . . . ) or ethers. Cooled air, nitrogen or other preferably inert gases and gas mixtures can also be used as cooling fluids.

In an embodiment of the sample carrier system in accordance with the invention, which can be combined with any of the embodiments already mentioned and with any of the embodiments yet to be named, unless contradictory thereto, at least one sample rack receptacle comprises a condensation water drain, in particular a condensation water channel or a conical bottom surface provided with an outlet opening.

Such a condensation drain is suitable for draining condensation water that collects in the sample carrier. For example, sample racks that have been stored in the refrigerator together with the samples until analysis tend to fog up at room temperature. This condensed moisture then collects in the sample rack receptacles or in the sample carrier.

### BRIEF DESCRIPTION OF THE DRAWINGS

Embodiment examples of the present invention are explained in more detail below using figures, wherein:

FIG. 1 shows an embodiment of a sample rack (front view);

FIG. 2. shows an embodiment of a sample rack (rear view);

FIG. 3 shows an embodiment of a sample carrier system;

FIG. 4 shows a rear view of the sample carrier system from FIG. 3;

FIG. 5 shows a schematic top view of an embodiment of a sample carrier system;

FIG. 6 shows a schematic top view of another embodiment of a sample carrier system;

FIG. 7 shows a schematic top view of another embodiment of a sample carrier system;

FIG. 8a shows a schematic top view of an additional embodiment of a sample carrier system;

FIG. 8b shows a schematic top view of two sections of the sample carrier system from FIG. 8a with different sample racks inserted into the sample carrier;

FIG. 9 shows another embodiment of a sample rack (rear view); and

FIG. 10 shows a schematic top view of an embodiment of a sample carrier system with identifier reader.

### DETAILED DESCRIPTION OF THE INVENTION

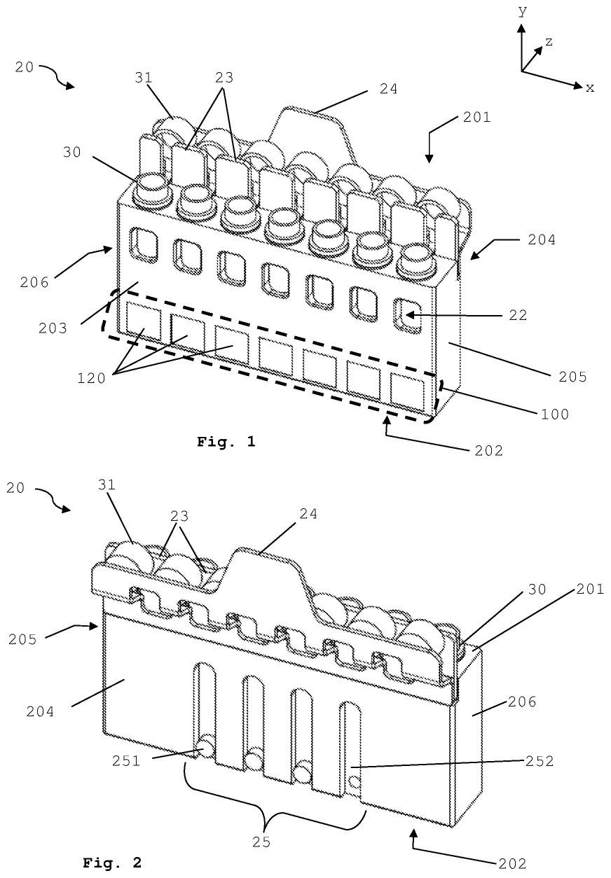

FIG. 1 shows an embodiment of a sample rack 20 in a front view. The sample rack 20 has a code arrangement 100 with a total of seven codes 120. In addition, the sample rack 20 has the same number of inspection windows 22 and the same number of sample tubes 30 in the sample tube receptacles. The lids 31 of the sample tubes are held in place by retaining elements 23 to prevent accidental snap-back. A support surface is provided behind the projections, on which the lids 21 are placed. In this example, the support surface is combined with the gripping device 24 for easier transport and better gripping of the sample rack 20. The sample rack 20 has a top side 201, a bottom side 202, a front side 203, a back side 204, a right side 205 and a left side 206. A coordinate system is also drawn in, which can be used to describe the position of individual receptacles relative to the position of a code.

FIG. 2 again shows a rear view of an embodiment of a sample rack 20. In addition to the different sides 201, 202, 203, 204, 205 and 206 of the sample rack already explained in FIG. 1, there are sample tubes 30 and their lids 31, retaining elements 23 and a gripping device 24. Further on, the mechanical means 25 can be seen, which enable the sample rack 20 to be assigned to a sample rack receptacle of a sample carrier (not shown here). The mechanical means 25 of the embodiment example shown here comprise four guide grooves 252 and three guide projections 252 blocking part of the guide grooves. The sample rack 20 can then be guided into the sample carrier (not shown here) via the non-blocked guide groove 252 and a guide projection in the sample rack receptacle of a sample carrier (not shown here), e.g. with a design comparable to the guide projections 251 shown. This only works, however, if the mechanical means 25 of the sample rack and the mechanical means of the sample rack receptacle actually cooperate, e.g. by being formed in an at least partially complementary manner.

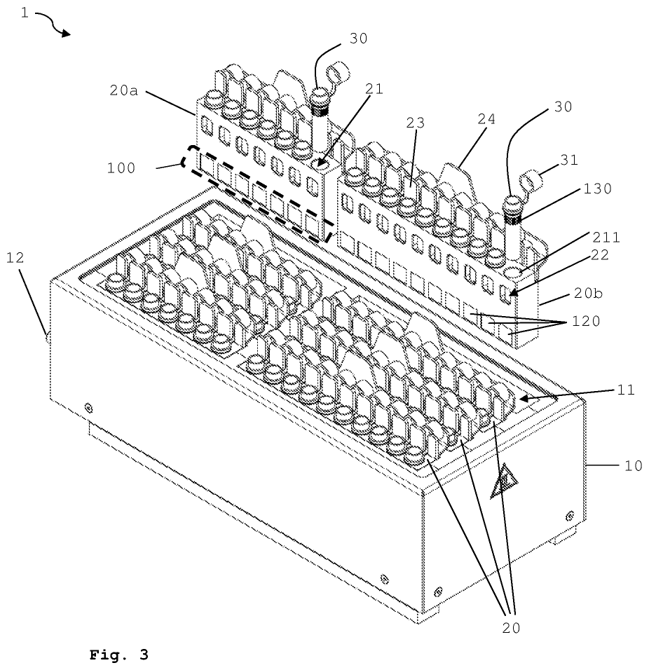

FIG. 3 shows an embodiment of a sample carrier system 1. The sample carrier system 1 comprises a sample carrier 10 and several sample racks 20. The sample carrier 10 comprises a temperature control unit 12 in the form of cooling fluid connections for a cooling fluid (e.g. water, isopropanol, air, nitrogen, . . . ) and has a total of eight sample rack receptacles 11. Also shown are eight sample racks 20, whereof two of the sample racks 20a, 20b are shown in a state not (yet) inserted into the sample carrier 10. The two sample racks 20a, 20b are essentially identical in construction, but for the sake of clarity not all reference numerals for both sample racks 20a, 20b are shown. The sample rack 20a on the left side of the picture comprises seven receptacles for sample tubes 21. Shown are six sample tubes 20a inserted in the sample rack 20a and one sample tube 30 not (yet) in the sample rack 20a. Furthermore, the sample rack 20a comprises a code arrangement 100 with a total of seven codes 120, i.e. one code 120 per receptacle 21. The otherwise identical sample rack 20b on the right side of the picture has ten receptacles for sample tubes 21. 9 sample tubes 30 are shown, which have been inserted into the sample rack and one sample tube 30 which is not (yet) in the sample rack 20b, on the basis of whose receptacle the position of a receptacle axis 210 is shown. The code arrangement 100 of the sample rack 20b comprises ten codes 120, also one code 120 per receptacle 21. Further marked in the sample rack 20b, but also part of the sample rack 20a, are inspection windows 22, openings 211 of the receptacles for the sample tubes 21, retaining elements 23 and a gripping device 24. A lid 31 and a sample tube code 130 are further exemplarily marked on one of the sample tubes 30.

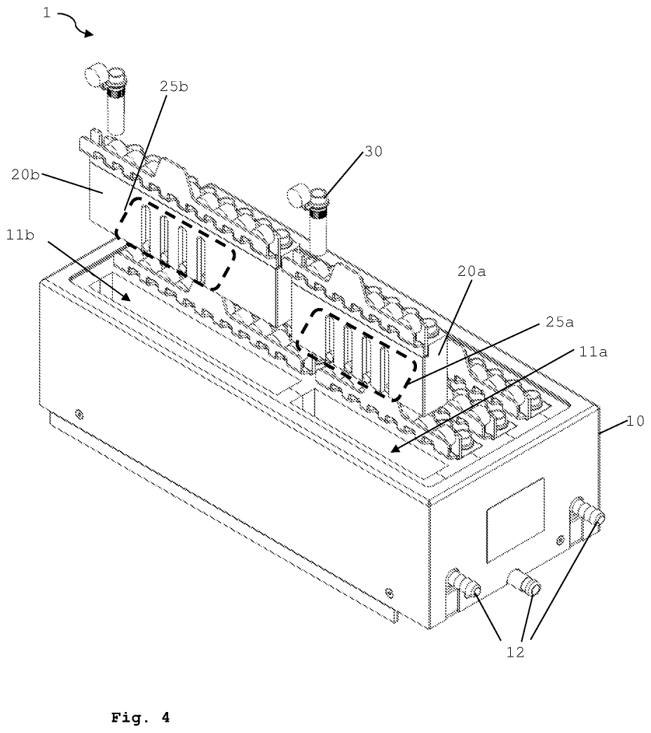

FIG. 4 shows a rear view of the sample carrier system 1 from FIG. 3, with the sample rack 20b on the left with its total of ten receptacles for sample tubes 30 and the sample rack 20a on the right with its seven receptacles for sample tubes. Clearly visible are the cooling fluid connections of the temperature control unit 12 of the sample carrier 10. Further visible are the mechanical means 25a, 25b of the sample racks 20a, 20b. It is noticeable that these are identically designed and it is therefore possible to insert the smaller sample rack 25a into both the left sample rack receptacle 11b and the right sample rack receptacle 11a. The sample rack 20a is therefore associated with two different sample rack receptacles 11a, 11b.

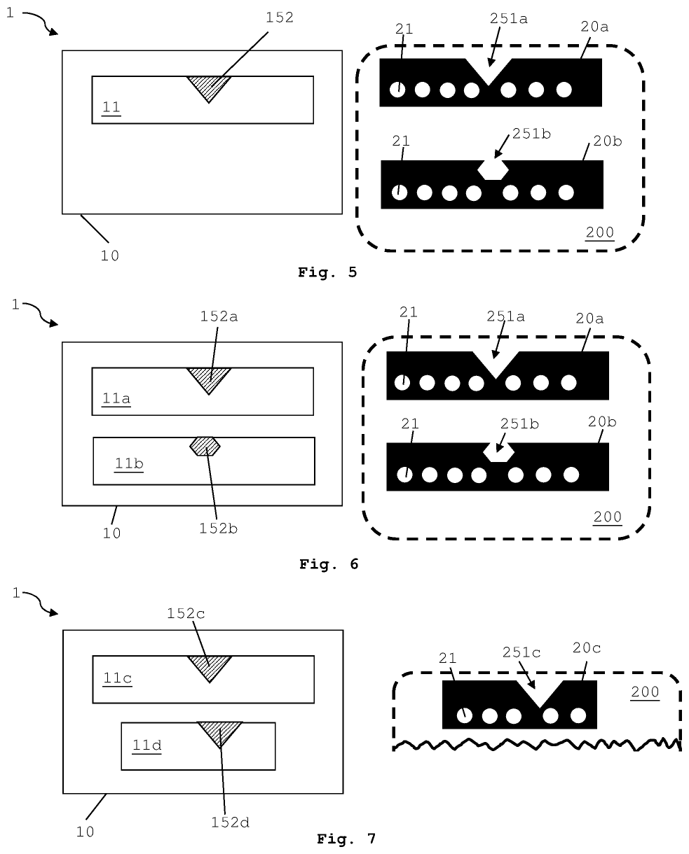

FIG. 5 shows a schematic bird's-eye view of an embodiment of a sample carrier system 1, which comprises a sample carrier 10 with a sample rack receptacle 11 and a set of sample racks 200 with two sample racks 20a, 20b of different design. Both sample racks 20a, 20b each have a total of seven receptacles 21 for sample tubes. The sample rack receptacle 11 has a guide projection 152, whereas only one sample rack 20a of the set 200 has a complementary guide groove 251a. The other sample rack 20b cannot be inserted into the sample rack receptable 11 of the sample carrier 10, because its guide groove 251b does not interact in a complementary way (e.g. according to the key-lock principle) with the guide projection 152 of the sample rack receptacle 11. Thus, only the one sample rack 20a belongs to the sample carrier 10 or its one sample rack receptacle 11.

FIG. 6 shows a schematic top view of another embodiment of a sample carrier system 1. This comprises a sample carrier 10 with two sample rack receptacles 11a, 11b and a set of sample racks 200 identical to the set 200 shown in FIG. 5. The guide projection 152a of the sample rack receptacle 11a is complementary to the guide groove 251a of the sample rack 20a, whereas the guide projection 152b of the sample rack receptacle 11b is complementary to the guide groove 251b of the sample rack 20b. Thus, one sample rack 20a, 20b each from the set 200 is associated with one sample rack receptacle 11a, 11b each of the sample carrier 10.

FIG. 7 shows a schematic top view of another embodiment of a sample carrier system 1, which comprises a sample carrier 10 with two sample carrier receptacles 11c, 11d of different sizes, which have identically designed guide projections 152c, 152d, and a set of sample racks 200, wherein only one of the sample racks 20c of the set 200 is shown. This sample rack 20c has a guide groove 251c, which is complementary to the guide projections 152c, 152d of the sample rack receptacles 252c, 252d. Thus, the sample rack 20c is associated with two, or in this case even all, sample rack receptacles 11c, 11d of the sample carrier 10. Since it is dimensioned in such a way that it fits into both receptacles 11c, 11d, it can be inserted into one or the other receptacle as required.

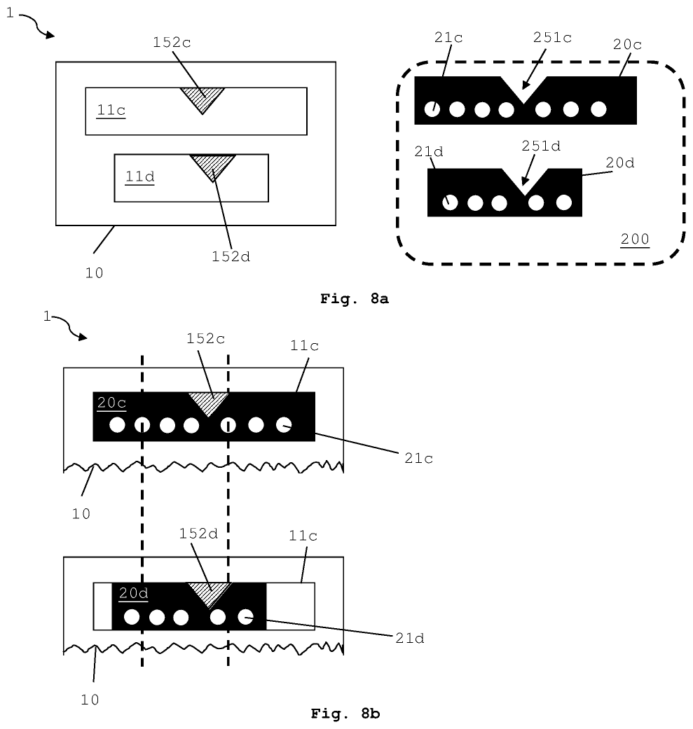

FIG. 8a shows a schematic top view of an additional embodiment of a sample carrier system 1. It comprises a sample carrier 10 with two sample carrier receptacles 11c, 11d of different sizes, which have identically designed guide projections 152c, 152d, and a set of sample racks 200. This set 200 comprises a sample rack 20c with seven receptacles 21c for sample tubes and a sample rack 20d with five receptacles 21d for sample tubes. The guide grooves 251c, 251d of both sample racks 20c, 20d are complementary to the identical guide projections 152c, 152d of the sample rack receptacles 11c, 11d. Due to the different dimensions of the sample rack receptacles 11c, 11d, the sample rack 20c can only be inserted into the sample rack receptacle 11c, despite the complementary mechanical means, whereas the sample rack 20d can be inserted into both sample rack receptacles 11c, 11d.

FIG. 8b shows a schematic top view of two sections of the sample carrier system 1 from FIG. 8a, once with sample rack 20c inserted into the sample rack receptacle 11c of sample carrier 10 and once with sample rack 20d inserted into the sample rack receptacle 11c of sample carrier 10. If one compares the position of the receptacles 21c (sample rack 20c in sample rack receptacle 11c) with the position of the receptacles 21d (sample rack 20d in sample rack receptacle 11c), one can see that they differ. The receptacles 21c of the sample rack 20c are located at a different position in the sample rack receptacle 11c than the receptacles 21d of the sample rack 20d (see e.g. dashed auxiliary lines). A pipetting robot is thus able to recognize that the wrong sample rack, even if it belongs to the sample rack receptacle, has been inserted into the sample carrier by mistake.

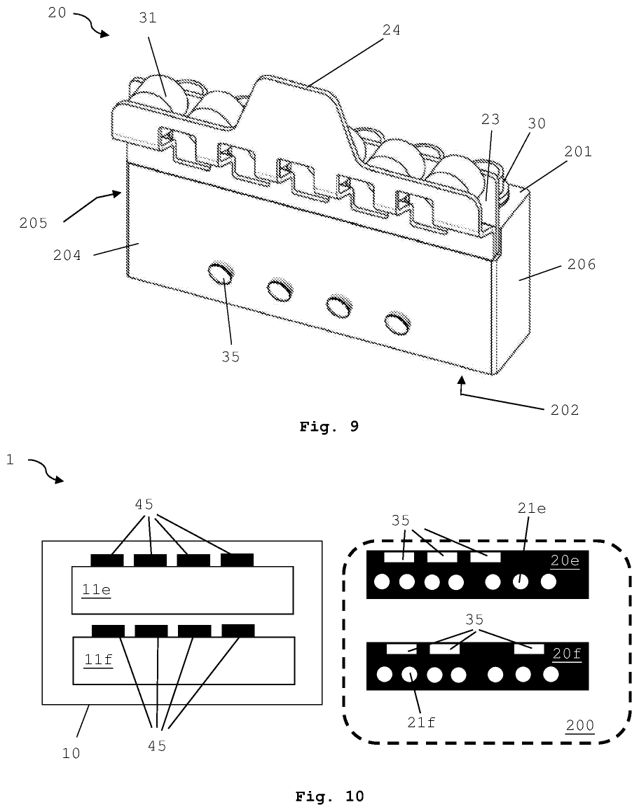

FIG. 9 shows a rear view of another embodiment of a sample rack 20. This sample rack essentially corresponds to a sample rack as already shown in FIGS. 1 and 2. However, the sample rack 20 differs from the sample rack 20 shown in FIG. 2 in the type of interacting means that characterize the affiliation of the sample rack receptacle and the sample rack. Instead of mechanical means, the sample rack 20 here comprises several, strictly speaking four, identifiers 35 in the form of magnets. The sample rack receptacle of the sample carrier (not shown here), on the other hand, comprises an identifier reader, for example in the form of four Hall sensors.

FIG. 10 shows a schematic top view of an embodiment of a sample carrier system 1, which comprises a sample carrier 10 with two sample rack receptacles 11e, 11f and a set of sample racks 200 with a total of two sample racks 20e, 20f. These are each equipped with three identifiers 35, e.g. in the form of magnets, whose arrangement around or on the sample rack differs for the two sample racks 20e, 20f. Sample rack 20e has, so to speak, a blank space at the fourth position, whereas sample rack 20f has a blank space at the third position. The sample rack receptacles 11e, 11f of sample carrier 10, on the other hand, each have four identifier readers 45, e.g. Hall sensors. These are arranged at comparable positions and are able to recognize at which of the four positions the inserted sample rack has markings 35 and at which not. For example, the sample rack receptacle 11e can be assigned the sample rack 20e with the identifier arrangement 1-1-1-0, whereas the sample rack receptacle 11f is assigned the sample rack 20f with the identifier arrangement 1-1-0-1.

List of reference numerals

| | |
|---|---|
| 1 | Sample carrier system |
| 10 | Sample carriers |
| 11, 11a, 11b, 11c, 11d, | Sample rack receptacle |
| 11e, 11f | |
| 12 | Temperature control unit |
| 15 | Mechanical means |
| | Sample rack receptacle |
| 151, 151a, 151b, 151c, | Guide groove |
| 151d | Sample rack receptacle |
| 152 | Guide projection |
| | Sample rack receptacle |
| 20, 20a, 20b, 20c, 20d, | Sample rack |
| 20e, 20f | |
| 200 | Set of sample racks |
| 201 | Top side of sample rack |
| 202 | Bottom side of sample rack |
| 203 | Front side of sample rack |
| 204 | Back side of sample rack |
| 205 | Right side of sample rack |
| 206 | Left side of sample rack |
| 21, 21a, 21b, 21c, 21d, | Receptacle for sample tubes |
| 21e, 21f | |
| 210 | Receptacle axis |
| 211 | Receptacle opening |
| 22 | Inspection window |
| 23 | Retaining element |
| 24 | Gripping device |
| 25, 25a, 25b | Mechanical means |
| | Sample rack |
| 251 | Guide groove |
| | Sample rack |
| 252, 252a, 252b, 252c, | Guide projection |
| 252d | Sample rack |
| 100 | Code arrangement |
| 120 | Code sample rack |
| 30 | Sample tubes |
| 31 | Lid |
| 130 | Sample tube code |
| 35 | Identifier |
| 45 | Identifier reader |

1. Sample rack (20), comprising at least one axially extended receptacle (21) for a sample tube (30) and a code arrangement (100) arranged on the outside of the sample rack (20), wherein the code arrangement (100) comprises information regarding the position of the at least one receptacle (21) as well as information regarding the total number of receptacles (21) and/or the dimension of the sample rack (20).

2. Sample rack (20) according to claim 1, wherein the code arrangement (100) comprises a code (120) associated with a receptacle (21) and comprising information regarding the position of said one receptacle (21).

3. Sample rack (20) according to claim 1, wherein the code arrangement (100) comprises a code (120) comprising information regarding the position of a plurality of receptacles (21), in particular information regarding the position of the plurality of receptacles (21) relative to the position of this code (120).

4. Sample rack (20) according to claim 1, comprising at least one inspection window (22) which allows the view into at least one receptacle (21).

5. Sample rack (20) according to claim 1, comprising retaining elements (23) for lids (31) of the sample tubes (30), in particular projections (23).

6. Sample rack (20) according to claim 1, comprising a gripping device (24), in particular at least one holding bracket and/or at least one holding tab (24).

7. Sample rack (20) according to claim 6, wherein a part of the gripping device (24) forms a support surface for lids (31) of the sample tubes (30).

8. Sample rack (20) according to claim 1, wherein at least one receptacle (21) comprises an empty code containing information regarding the absence of a sample tube (30) in the receptacle (21).

9. Sample carrier system (1), comprising a sample carrier (10) having at least one sample rack receptacle (11) and a set of sample racks (20), wherein the sample rack receptacle (11) and the sample racks (20) have interacting means which characterize their affiliation.

10. Sample carrier system (1) according to claim 9, wherein the interacting means are interacting mechanical means (15, 25) which are designed such that only certain sample racks (20) of the set can be inserted into the sample carrier (10) in the desired position.

11. Sample carrier system (1) according to claim 9, wherein the interacting means comprise at least one identifier (35) and at least one identifier reader (45), in particular at least one Hall sensor as identifier reader (45) and at least one magnet as identifier (35).

12. Sample carrier system (1) according to claim 9, wherein a specific sample rack (20) from the set is associated only with a specific sample rack receptacle (11).

13. Sample carrier system (1) according to claim 9, wherein the sample carrier (10) comprises at least two sample rack receptacles (11c, 11c) of different dimensions, to which one and the same specific sample rack (20c) from the set is associated.

14. Sample carrier system (1) according to claim 13, wherein the set comprises at least one further sample rack (20d), to which at least one of the two sample rack receptacles (11c, 11d) of different dimensions is associated, and wherein the at least one further sample rack (20d) has in particular a different dimension and/or different total number of receptacles (21) and wherein preferably the position of the receptacles (21) of the different sample racks (20c, 20d) in the same sample rack receptacle (11c, 11d) differs.

15. Sample carrier system (1) according to claim 10, wherein the interaction of the mechanical means (15, 25) is based on the key-lock principle.

16. Sample carrier system (1) according to claim 10, wherein the interacting mechanical means (15, 25) are formed by at least one of the following or a combination thereof:
at least one guide groove (251) on a sample rack (20), in particular on its outside, and at least one guide projection (152) on a sample rack receptacle (11), in particular on at least one side delimiting the sample rack receptacle (11);
at least one guide projection (252) on a sample rack (20), in particular on its outside, and at least one guide groove (151) on a sample rack receptacle (11), in particular on at least one side delimiting the sample rack receptacle (11);
at least one recess on a sample rack (20), in particular on its bottom, and at least one pin on a sample rack receptacle (11), in particular on the bottom thereof;
at least one pin on a sample rack (20), in particular on the bottom thereof, and at least one recess on a sample rack receptacle (11), in particular on the bottom thereof.

17. Sample carrier system (1) according to claim 9, wherein the sample carrier (10) comprises at least one temperature control unit (12) which enables heating, cooling and/or maintaining a temperature or a temperature range, in particular at least one line for a cooling fluid and/or at least one Peltier element.

18. Sample carrier system (1) according to claim 9, wherein at least one sample rack receptacle (11) comprises a condensation water drain, in particular a condensation water channel or a conical bottom surface provided with an outlet opening.
